(19) United States
(12) Patent Application Publication
(10) Pub. No.: US 2009/0303836 A1
(43) Pub. Date: Dec. 10, 2009

(54) DEVICE AND METHOD FOR SCARING OFF ANIMALS FROM A PARKED MOTOR VEHICLE

(75) Inventors: Klaus Rottenwöhrer, Regensburg (DE); Andreas Weigand, Regensburg (DE); Lorand de Ouvenou, Bernhardswald (DE)

Correspondence Address: King & Spalding LLP, 401 Congress Avenue, Suite 3200, Austin, TX, 78701, US

(73) Assignee: Continental Automotive GmbH

(21) Appl. No.: 12/306,287

(22) PCT Filed: Aug. 31, 2007
(86) PCT No.: PCT/EP07/59083

§ 371 Date: Dec. 23, 2008

(30) Foreign Application Priority Data
Sep. 19, 2006 (DE) 102006043995.3

(51) Int. Cl. A01M 29/00

(52) U.S. Cl. 367/139

(57) ABSTRACT

In a device and a method for scaring off animals, in particular martins, from a parked motor vehicle, the piezoinjectors (10) which are not used in a parked motor vehicle are used as acoustic transducers by means of an actuator (30, 40, 50). The acoustic transducers irradiate, for example, an ultrasonic signal with which animals are scared off.

### CROSS-REFERENCE TO RELATED APPLICATIONS

This application is a U.S. National Stage Application of International Application No. PCT/EP2007/059083 filed Aug. 31, 2007, which designates the United States of America, and claims priority to German Application No. 10 2006 043 995.3 filed Sep. 19, 2006, the contents of which are hereby incorporated by reference in their entirety.

### TECHNICAL FIELD

The present invention relates to a device and a method for scaring off animals, in particular martens, from a parked motor vehicle and a corresponding method.

### BACKGROUND

A motor vehicle which is parked after a long journey releases its engine heat into its immediate vicinity over a relatively long period of time. By releasing the engine heat, the engine compartment of the motor vehicle heats up and thus provides an attractive shelter for different animals, for instance martens, particularly on cold days. If these animals stay in the engine compartment, this frequently results in them gnawing on soft materials built into the engine compartment. Plastic and rubber which are used as pipes, cables and damping mats for acoustic insulation feature among these materials for instance. The damage caused by gnawing animals results in the worst case in interference to the operation of the motor vehicle, such as breaks in the ignition cable, as a result of which the start-up of the motor vehicle can no longer be ensured.

Damage of this type firstly generates a certain dissatisfaction with respect to the user of the motor vehicle. In the negative case, poor motor vehicle quality is assumed to be the cause of this dissatisfaction, since it is frequently not possible to immediately identify the cause of the damage. A loss of reputation with respect to the manufacture of the motor vehicle also results in this way in addition to the material damage.

To guard against marten damage for instance, materials are used in the engine compartment which are not gnawed by animals. A further alternative consists in encasing endangered lines or pipes with a sufficiently resistant material. These two alternatives are however associated with additional costs and do not always prevent damage in the engine compartment as a result of gnawing animals.

A further alternative consists in installing additional electrical devices in the engine compartment, which emit acoustic ultrasound signals in order to scare off and chase away animals. These additional devices generate additional costs, which are incurred both for the manufacture and also for the installation of additional devices. Furthermore, they take up space in the engine compartment which is not always available.

### SUMMARY

According to various embodiments, a device and a method for scaring off animals from a parked motor vehicle can be provided, which can be realized with lower costs in comparison with the prior art.

According to an embodiment, a device for scaring off animals, in particular martens, from a parked motor vehicle may have the following features: a) at least one piezoelectric and/or electromagnetic switching or sensor element installed for operation of the motor vehicle, which is not used for the operation of the motor vehicle when the motor vehicle is parked, and b) a controller of the at least one piezoelectric and/or electromagnetic switching or sensor element, such that the at least one piezoelectric switching or sensor element can be actuated as an acoustic converter.

According to a further embodiment, the at least one piezoelectric and/or electromagnetic switching or sensor element of which can be a piezo and/or magnet injector and/or an ultrasound sensor, a parking aid and/or an electromagnetically operated inlet and/or outlet valve of an internal combustion engine. According to a further embodiment, it may be possible to generate a cyclical or acyclical acoustic signal with the controller thereof in the at least one switching or sensor element. According to a further embodiment, the controller may have a first oscillator, with which the at least one switching or sensor element can be actuated with changeable frequencies. According to a further embodiment, the controller may have a second oscillator, with which the first oscillator can be switched on and off. According to a further embodiment, the device may have at least one random generator, with which the acoustic signal can be emitted variably. According to a further embodiment, the device may have a sensor for identifying an animal invading the engine compartment.

According to another embodiment, a method for scaring off animals from a parked motor vehicle, may have the following steps: a) identifying that the motor vehicle has been parked; b) generating an alternating voltage signal in a selected frequency range; and c) forwarding the alternating voltage signal to a piezoelectric and/or electromagnetic switching element and/or sensor element of the motor vehicle which was used during operation of the motor vehicle so that the piezoelectric and/or electromagnetic switching and/or sensor element emits an acoustic signal.

According to a further embodiment, the selected frequency range may lie in the ultrasound range. According to a further embodiment, the method may have the additional step: Changing a frequency of the alternating voltage signal. According to a further embodiment, the method may have the additional step: Cyclical or acyclical switching on and off of the alternating voltage signal. According to a further embodiment, the method may have the additional step: Forwarding the alternating voltage signal to at least one piezoinjector and/or at least one ultrasound sensor of a park distance control system. According to a further embodiment, the method may have the additional step: Varying the alternating voltage signal in terms of duration and/or intensity and/or emission sequence with the aid of a random generator and/or varying an emission source of the acoustic signal by forwarding the alternating voltage signal by means of a random generator to randomly alternating piezocomponents, like piezoinjectors and/or ultrasound sensors of a park distance control system. According to a further embodiment, the switching and/or sensor element only may emit an acoustic signal if an animal has been detected in the vicinity of the engine compartment. According to a further embodiment, a sensor for identifying an animal, in particular a microphone, may record acoustic signals and these recorded acoustic spectra may be compared with stored spectra, with an animal being ascertained in a comparable spectra between recorded and stored spectra about an animal.

### BRIEF DESCRIPTION OF THE DRAWINGS

Embodiments are described in more detail with reference to the drawing, in which;

FIG. 1 shows a schematic representation of a configuration of the apparatus according to an embodiment and

FIG. 2 shows a flow chart of an embodiment of the method.

### DETAILED DESCRIPTION

The above device, in particular a marten alarm, includes the following features: at least one installed and/or magnetic switching or sensor element for the operation of the motor vehicle, which, in the case of a parked motor vehicle, is not used for the operation of the motor vehicle and a controller of the at least one switching or sensor element such that the at least one switching or sensor element can be actuated as an acoustic converter.

In present day motor vehicles, piezoelectric and/or magnetic components are used as switching and sensor elements. As a function of the electrical actuation of these piezoelectric and/or magnetic components, it is possible to use these as a switching element, sensor element or as an acoustic converter.

As for instance piezoelectric and/or magnetic injection apparatuses, which are also referred to as piezo and/or magnet injectors, are not used in a parked motor vehicle, these injectors can by contrast be used for their actual purpose as acoustic converters. These injectors are also located in the engine compartment, so that an acoustic signal emitted by piezoinjectors would deter gnawing animals, like for instance martens, from the engine compartment. A device of this type does not require the installation of additional components. The already existing controller of the injectors or generally of the piezoelectric and/or magnetic switching and sensor elements is to be supplemented such that an actuation of these piezoelectric and/or magnetic switching and sensor elements as acoustic converters is ensured.

As piezoelectric and/or magnetic components, which are used by contrast to their other function during the operation of the motor vehicle in the case of a parked motor vehicle as acoustic converters, all switching and sensor elements used in the motor vehicle are conceivable. The already afore-cited injectors form part of these switching and sensor elements. An additional example includes the ultrasound sensors, which are used in a park distance control system. Electromagnetically powered inlet and/or outlet valves can also be used.

According to one embodiment, cyclical or acyclical acoustic signals can be generated by the controller in the switching or sensor elements. To this end, the controller may preferably have a first oscillator, with which the at least one switching or sensor element can be actuated with changeable frequencies. According to a further embodiment, a second oscillator is used, with which the first oscillator can be intentionally switched on and/or off.

The present invention likewise includes a motor vehicle with a device for scaring off animals, as was described above.

The method for scaring off animals from a parked motor vehicle has the following steps: identifying that the motor vehicle has been parked, generating an alternating voltage signal in a selected frequency range and forwarding the alternating voltage signal to a piezoelectric switching and/or sensor element of the motor vehicle which is used during operation of the motor vehicle, said element being used in the parked motor vehicle so that the switching and/or sensor element emits an acoustic signal.

To adjust the above method to scaring off different animals, it is possible to select a certain frequency range of the acoustic signal to be sent out in a controller of the switching and/or sensor elements. According to one embodiment, the ultrasound range is used in order to scare off martens.

It can also be preferred to change a frequency of the alternating voltage signal in order to actuate the piezoelectric switching and/or sensor elements, as well as to actuate a cyclical or acyclical switching on and off of the alternating voltage signal.

According to various embodiments, an apparatus is disclosed, with which acoustic signals can be generated in a parked motor vehicle. These acoustic signals are unpleasant for different types of animals, so that the animals are scared off by these acoustic signals and kept away from the parked motor vehicle. This prevents damage to the engine compartment of the parked motor vehicle for instance, which is caused by these animals biting or gnawing.

With the aid of the above device, a frequency range of the acoustic signal can be set arbitrarily as a function of the type of animal to be scared off for instance. It is likewise conceivable to automatically change this frequency range in order to cover a certain frequency spectrum of the acoustic signal. This ensures that animal species which respond to different acoustic signals are scared off at the same time.

In order to generate the acoustic signal, the various embodiments use electrical switching and/or sensor elements 10, which are already installed in the motor vehicle. During operation of the motor vehicle, piezoelectric and/or magnetoelectric switching and/or sensor elements 10 are used according to their function, while they remain unused in the parked motor vehicle. Fuel is thus injected for instance via a piezoinjector 10 as a piezoelectric switching element in the motor vehicle into the engine. A further example is an ultrasound sensor, which is installed in the front or rear bumper of the motor vehicle. During operation of the motor vehicle, the ultrasound sensor of a parking distance control system assist the driver by measuring the distance of the automobile from its object. If the motor vehicle is parked, the piezoinjector and the ultrasound sensor remain unused. On the basis of this, all piezoelectric switching and sensor elements of the motor vehicle can be applied to the present invention, which have no function to fulfill in the case of a parked motor vehicle.

The afore-cited switching and/or sensor elements 10 or a selection thereof are actuated with the aid of a controller 30, 40, 50 configured therefor such that they emit acoustic signals of a selectable frequency range. On this technical basis, animals are scared off by the generated acoustic signals without an additional device, like for instance a marten alarm, having to be installed in the motor vehicle.

Furthermore, the use of the switching and/or sensor elements already present in the motor vehicle achieves a different acoustic effect than the use of the known marten alarm. If a plurality of piezoinjectors 10 present in the motor vehicle is used to generate an acoustic signal, this acoustic signal, for instance an ultrasound signal, is not radiated from a particular point of origin. Instead, the acoustic signal is emitted by the whole engine block and is as a result amplified, since the piezoinjector 10 is fixedly connected to the engine block and the engine block forms an impact sound bridge. To also avoid the animals becoming familiar with the deterring acoustic signal, this is varied in terms of its intensity and/or duration and/or emission sequence in accordance with another embodiment with the aid of a random generator.

According to a further embodiment, different piezoelectric switching and sensor elements can be actuated at the same time or alternately as acoustic converters. It is possible to select in this way whether the acoustic signal is radiated from a fixed position or from changing positions on the parked motor vehicle. In addition to the afore-cited application of a random generator, it is likewise conceivable to radiate the acoustic signal by way of continuously alternating piezoelectric components with the aid of the random generator. This prevents the animals to be scared off from identifying a radiation pattern and thus the presence of a nonhazardous machine.

With the aid of the afore-cited device, piezoelectric switching and/or sensor elements 10 are thus available in the motor vehicle as acoustic converters. The actuation of the piezoelectric switching and/or sensor elements 10 may preferably be carried out by the operating control device 20 of the motor vehicle. If the piezoinjectors 10 are used as acoustic converters, it is likewise conceivable to integrate the controller of the acoustic converter into the control device of the injection system. For this purpose, only simple extensions to the already available control circuits are necessary.

According to various embodiments, material changes or other protective measures are thus no longer needed in the engine compartment, since animals are already kept away with an apparatus installed in the motor vehicle.

The various embodiments are explained with the example of the use of a piezoinjector 10 as an acoustic converter in the parked motor vehicle. It is likewise conceivable to actuate a plurality of piezoinjectors 10 and/or additional piezoelectric sensor or switching elements of the parked motor vehicle at the same time or alternately, in order to generate the deterring acoustic signals.

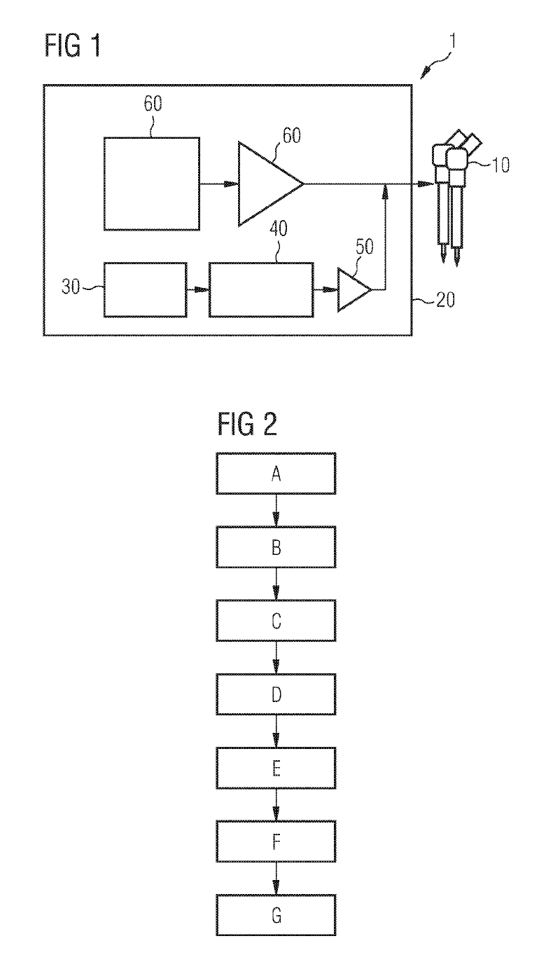

A schematic circuit diagram for actuating the piezoinjector 10 is shown in FIG. 1. The operating control device 20 of the motor vehicle includes an injection controller and/or an injection controlling device 60. The injection controller 60 controls during the operation of the motor vehicle, in other words with a running engine, the injection of fuel by way of the piezoinjector 10. To use the piezoinjector 10 in the parked motor vehicle as an acoustic converter, the injection controller 60 or the operating control device 20 is extended by a controller 30, 40, 50 for piezoelectric acoustic converters. The controller 30, 40, 50 may preferably consist of at least one oscillator 30. The piezoinjector 10 is powered with an alternating voltage signal by way of the oscillator 30, so that acoustic signals can be generated in the piezoinjector 10. The alternating voltage signal generated by the oscillator 30 can be changed in terms of its frequency, so that acoustic signals of different frequency ranges are generated. These frequencies are varied automatically for instance in order to cover a selected acoustic frequency spectrum. It is likewise conceivable to fixedly specify this frequency so that an ultrasound signal or a signal of another frequency range is emitted.

According to a further embodiment, a further oscillator 40 is used in order to switch the oscillator 30 on and off. Cyclical and/or acyclical acoustic signals can thus be generated with the aid of the oscillator 40, with which animals are scared off.

Before the alternating voltage signal generated by the oscillator 30 reaches the piezoinjector 10, it may be preferably still amplified in an amplifier 50.

The use of the afore-described device 1 for scaring off animals in a motor vehicle may preferably operate according to the flow chart shown in FIG. 2. In step A, it is firstly identified that the motor vehicle has been parked and/or an animal is present in the engine compartment. One indicator for a parked motor vehicle is an engine which is not running or a switched off ignition or a detached spark plug. One indicator for an animal in the engine compartment is for instance an activated movement sensor or a briefly interrupted light barrier. Or however a microphone identifies the surrounding noises. Each specific animal generates dedicated noises when approaching, nibbling etc. These noises are stored in a non-volatile memory. With a positive comparison between the identified and stored noises, an animal is identified. Different animals can thus be detected. The device 10 is not activated if a dog or a cat is located in the vicinity of the engine compartment.

In step B, the circuit 30, 40, 50 is then activated to scare off animals, so that in step C the oscillator 30 generates the alternating voltage signal. The frequency of this alternating voltage signal is fixedly determined, is varied or can be adjusted by the user or manufacturer of the motor vehicle, so that the alternating voltage signal is generated in a selected frequency range.

Before the alternating voltage signal is forwarded to one or a plurality of piezoelectric switching and/or sensor elements (step F), the oscillator 40 may preferably switch the alternating voltage signal on and off (step D). This switching on and off can be applied both in a cyclical and/or acyclical manner. It is likewise possible for phases of cyclical acoustic signals to alternate with phases of an acyclical acoustic signal.

In step E, the amplifier 50 amplifies the alternating voltage signal before it is forwarded to the piezoinjector 10.

If the operating control device 20 or the controller 30, 40, 50 in step G identifies that the motor vehicle resumes its operation, the afore-cited method is terminated.

The different preferred steps of the afore-cited method are combined again below:
A Identifying that the motor vehicle has been parked
B Activating the circuit 30, 40, 50 for scaring off animals,
C Generating an alternating voltage signal with a changeable frequency,
D Cyclical or acyclical switching on and off of the alternating voltage signal,
E Amplifying the alternating voltage signal,
F Forwarding the alternating voltage signal to at least one piezoelectric switching and/or sensor element and
G Terminating the method, if the operation of the motor vehicle is started, for instance by switching on the ignition.

What is claimed is:

1. A device for scaring off animals from a parked motor vehicle comprising:
a) at least one of a piezoelectric and electromagnetic switching or sensor element installed for operation of the motor vehicle, which is not used for the operation of the motor vehicle when the motor vehicle is parked, and
b) a controller for the at least one of the piezoelectric and electromagnetic switching or sensor element operable to actuate the at least one of the piezoelectric switching and electromagnetic switching or sensor element to operate as an acoustic converter.

2. The device according to claim 1, wherein the at least one of the piezoelectric and electromagnetic switching or sensor element is at least one of a piezo injector, a magnet injector, an ultrasound sensor, a parking aid, an electromagnetically operated inlet valve and an electromagnetically operated outlet valve of an internal combustion engine.

3. The device according to claim 1, wherein it is possible to generate a cyclical or acyclical acoustic signal with the controller thereof in the at least one of the piezoelectric and electromagnetic switching or sensor element.

4. The device according to claim 1, wherein the controller comprises a first oscillator, with which the at least one of the piezoelectric and electromagnetic switching or sensor element can be actuated with changeable frequencies.

5. The device according to claim 4, wherein the controller comprises a second oscillator, with which the first oscillator can be switched on and off.

6. The device according to claim 1, comprising at least one random generator, with which the acoustic signal can be emitted variably.

7. The device according to claim 1, comprising a sensor for identifying an animal invading the engine compartment.

8. A method for scaring off animals from a parked motor vehicle, comprising the following steps:
a) determining that the motor vehicle has been parked;
b) generating an alternating voltage signal in a selected frequency range; and
c) feeding the alternating voltage signal to at least one of a piezoelectric and electromagnetic switching element or sensor element of the motor vehicle which was used during operation of the motor vehicle so that the at least one of the piezoelectric and electromagnetic switching or sensor element emits an acoustic signal.

9. The method according to claim 8, wherein the selected frequency range lies in the ultrasound range.

10. The method according to claim 8, comprising the additional step:
Changing a frequency of the alternating voltage signal.

11. The method according to claim 8, comprising the following step:
Cyclical or acyclical switching on and off of the alternating voltage signal.

12. The method according to claim 8, comprising the additional step:
feeding the alternating voltage signal to at least one piezoinjector or at least one ultrasound sensor of a park distance control system.

13. The method according to claim 8, comprising the additional step:
Varying the alternating voltage signal in terms of at least one of duration, intensity, emission sequence with the aid of a random generator, and varying an emission source of the acoustic signal by forwarding the alternating voltage signal by means of a random generator to randomly alternating piezocomponents of a park distance control system.

14. The method according to claim 8, wherein the at least one of the piezoelectric and electromagnetic switching or sensor element only then emitting an acoustic signal if an animal has been detected in the vicinity of the engine compartment.

15. The method according to claim 14, wherein a sensor for identifying an animal which records acoustic signals and these recorded acoustic spectra being compared with stored spectra, with an animal being ascertained in a comparable spectra between recorded and stored spectra about an animal.

16. The method according to claim 8, comprising the additional step:
feeding the alternating voltage signal to at least one piezoinjector and at least one ultrasound sensor of a park distance control system.

17. The method according to claim 13, the randomly alternating piezocomponents are at least one of piezoinjectors and ultrasound sensors of a park distance control system.

18. The method according to claim 15, wherein the sensor is a microphone.

19. A motor vehicle comprising:
a) at least one of a piezoelectric and electromagnetic element installed for operation of the motor vehicle, which is not used for the operation of the motor vehicle when the motor vehicle is parked, and
b) a controller for the at least one of the piezoelectric and electromagnetic element, operable to control the at least one of the piezoelectric switching and electromagnetic switching or sensor element to operate as an acoustic converter.

20. The motor vehicle according to claim 19, wherein the at least one of the piezoelectric and electromagnetic element is at least one of a piezo injector, a magnet injector, an ultrasound sensor, a parking aid, an electromagnetically operated inlet valve and an electromagnetically operated outlet valve of an internal combustion engine.
